(19) United States
(12) Patent Application Publication
(10) Pub. No.: US 2012/0024705 A1
(43) Pub. Date: Feb. 2, 2012

(54) Process for treating waste water and nozzle therefor

(76) Inventor: Sze Huen Chong, Singapore (SG)

(21) Appl. No.: 12/844,835

(22) Filed: Jul. 28, 2010

(51) Int. Cl. C02F 1/48; B05B 1/14

(52) U.S. Cl. 204/554; 239/589

(57) ABSTRACT

In an apparatus including two opposite conductive electrodes mounted in an opening of an insulating shroud filled with pressurized air, a support for supporting the shroud, the support being in communication with the opening to define an aerating zone adjacent to the opening, a collection tank under the aerating zone, and a nozzle disposed in the aerating zone, the nozzle being in communication with a waste water source, a process for treating waste water comprising energizing the electrodes to generate arc in a gap between the electrodes as the pressurized air passing through the gap; moving the arc to the aerating zone with contaminants and water components of waste water being shot out in fine spray from the nozzle; and vaporizing the fine spray as when it contacts the arc so as to neutralize the contaminants.

### BACKGROUND OF THE INVENTION

1. Field of Invention

The invention relates to waste water treatment and more particularly to a process for treating waste water and an improved nozzle therefore.

2. Description of Related Art

Waste water treatment is a process of removing contaminants from waste water. It includes physical, chemical, and biological processes to remove physical, chemical and biological contaminants. Its objective is to produce a treated effluent and a solid waste or sludge suitable for discharge or reuse back into the environment.

A typical process for treating a waste stream comprises subjecting the waste stream to solvent extraction to reduce phenol content of the waste stream to less than 100 ppm, treating the waste stream in a conditioning zone with nutrients, adjusting concentration, pH and temperature of the waste stream to be within a pH range of about 6.4 to 7.6, a temperature range of about 15 degree Celsius to 35 degree Celsius, and BOD (Biochemical Oxygen Demand) range of about 350 to 800 ppm, agitating the waste stream in an aerating zone in contact with activated sludge containing aerobic bacteria, and settling the activated sludge from the waste stream to provide a purified water stream.

The advancements of process for treating waste water are always desired since waste water pollution is a great threat to the environment.

### SUMMARY OF THE INVENTION

It is therefore one object of the invention to provide in an apparatus including two opposite conductive electrodes mounted in an opening of an insulating shroud filled with pressurized air, a support for supporting the shroud, the support being in communication with the opening to define an aerating zone adjacent to the opening, a collection tank under the aerating zone, and a nozzle disposed in the aerating zone, the nozzle being in communication with a waste water source, a process for treating waste water comprising the steps of energizing the electrodes to generate arc in a gap between the electrodes as the pressurized air passing through the gap; moving the arc to the aerating zone with contaminants and water components of waste water being shot out in fine spray from the nozzle; and vaporizing the fine spray as when it contacts the arc so as to neutralize the contaminants.

The above and other objects, features and advantages of the invention will become apparent from the following detailed description taken with the accompanying drawings.

### BRIEF DESCRIPTION OF THE DRAWINGS

FIG. 1 is an exploded view of a nozzle and an externally threaded end portion of a waste water line for treating waste water according to the invention;

FIG. 2 is a perspective view of the assembled nozzle;

FIG. 3 is a longitudinal sectional view of assembled nozzle and the threaded end portion;

FIG. 4 is a schematic view in part section showing an apparatus for treating waste water according to the invention; and

FIG. 5 is a flowchart illustrating a process for treating waste water according to the invention.

### DETAILED DESCRIPTION OF THE INVENTION

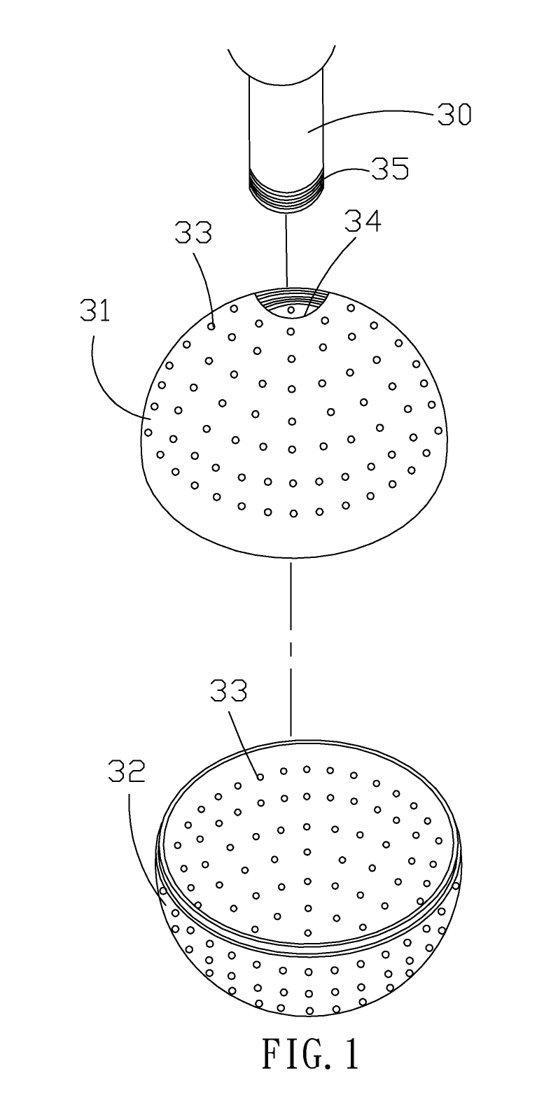

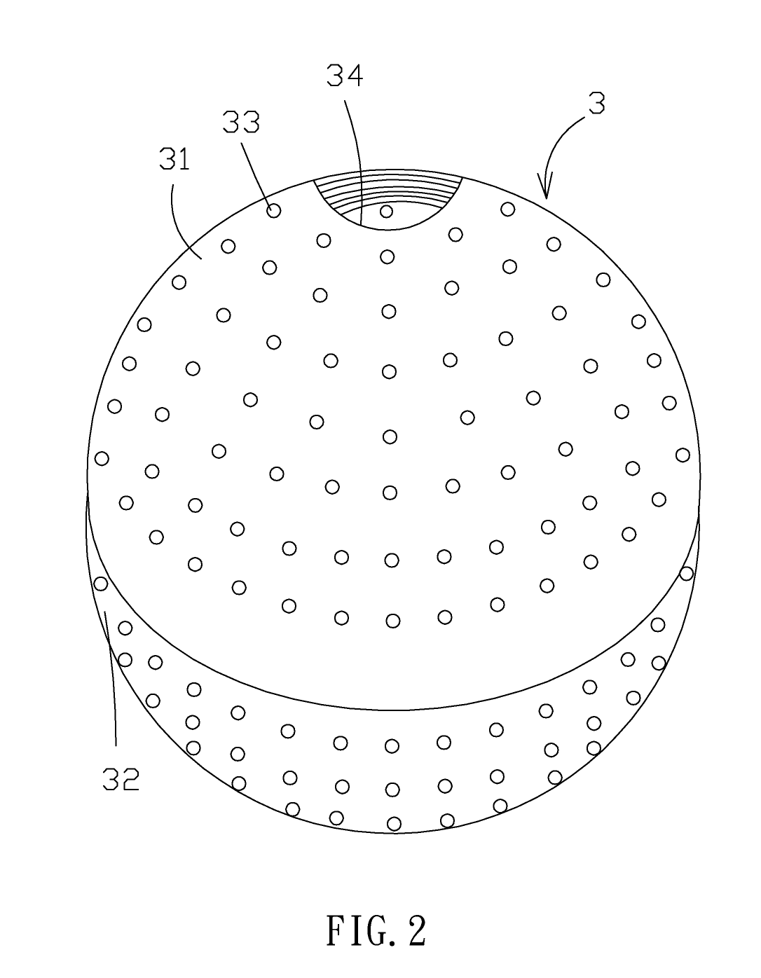

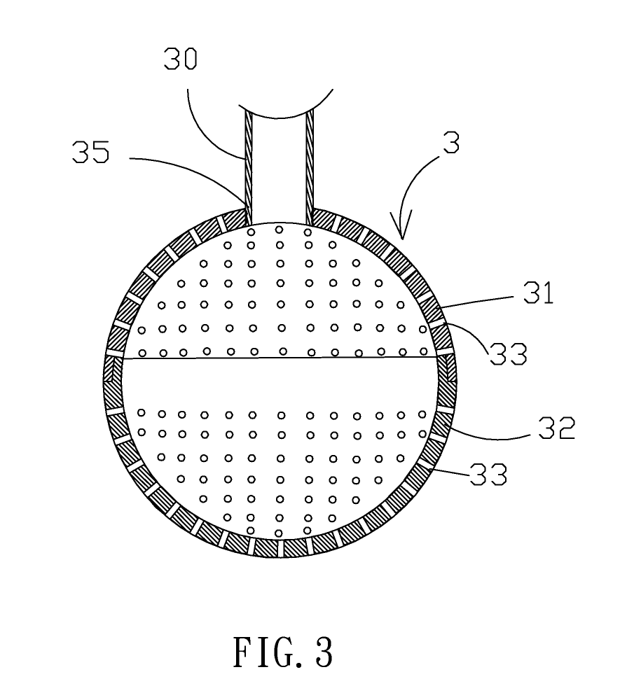

Referring to FIGS. 1 to 3, a nozzle 3 for treating waste water in accordance with the invention is shown.

The nozzle 3 is of spherical and comprises a first half 31 including an annular, projecting, internally threaded section around the mouth, a threaded hole 34 through a center of the first half 31, and a plurality of apertures 33 on surface of the first half 31;

and a second half 32 including a plurality of apertures 33 on surface, and an annular, projecting, externally threaded section around the mouth threadedly secured to the externally threaded section to form the nozzle 3.

Preferably, the diameter of the aperture 33 is in the range of 0.1 mm to 5 mm.

A waste water line 30 has an externally threaded end portion 35 adapted to secure to the threaded hole 34 to connect the waste water line 30 and the nozzle 3 together.

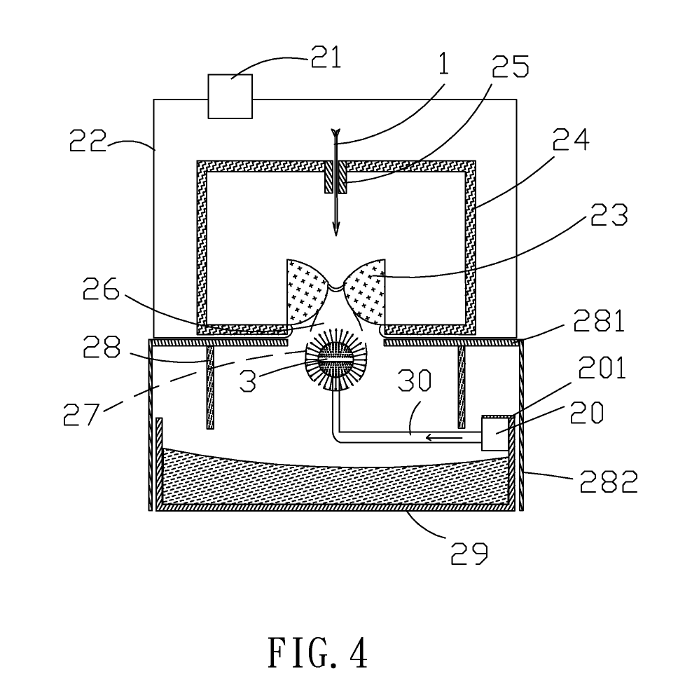

Referring to FIG. 4, an apparatus for treating waste water in accordance with the invention comprises the following components as discussed in detail below.

A high voltage source 21 supplies high voltage power to two opposite conductive electrodes 23 with a gap formed there between by means of a power cord 22. The electrodes 23 are mounted on a bottom opening 26 of an insulating shroud 24 and are disposed in the shroud 24. The shroud 24 has a top channel 25 in fluid communication with a gas line (not shown) so that pressurized gas (e.g., air) 1 may pass the gap via the channel 25 and the gas-fill space of the shroud 24.

A support 28 comprises four side walls (only two are shown) 282 and a top 281 having an opening aligned with the opening 26 there above. The shroud 24 is mounted on the top 281. A collection tank 29 is mounted in the support 28. A waste water source 20 is secured to a bracket 201 on a top edge of the collection tank 29. The waste water line 30 connects the nozzle 3 and the waste water source 20 together.

In operation, air moves in the rate of about 10 meter/second from the channel 25 so that arc may occur in the gap between the electrodes 23 which are energized by power supplied from the high voltage source 21. The arc results in a very high temperature (e.g., in the rage of about 500° C. to about 7,000° C. with an average of about 1,000° C.). The arc further moves to an aerating zone 27 around the nozzle 3. Contaminants and water components in the waste water shoot out in a fine spray from the nozzle 3. The fine spray is simultaneously vaporized by the arc when it contacts the arc. The toxic contaminants are thus neutralized. Cooled water and treated effluent fall into the collection tank 29 for discharge or reuse back into the environment.

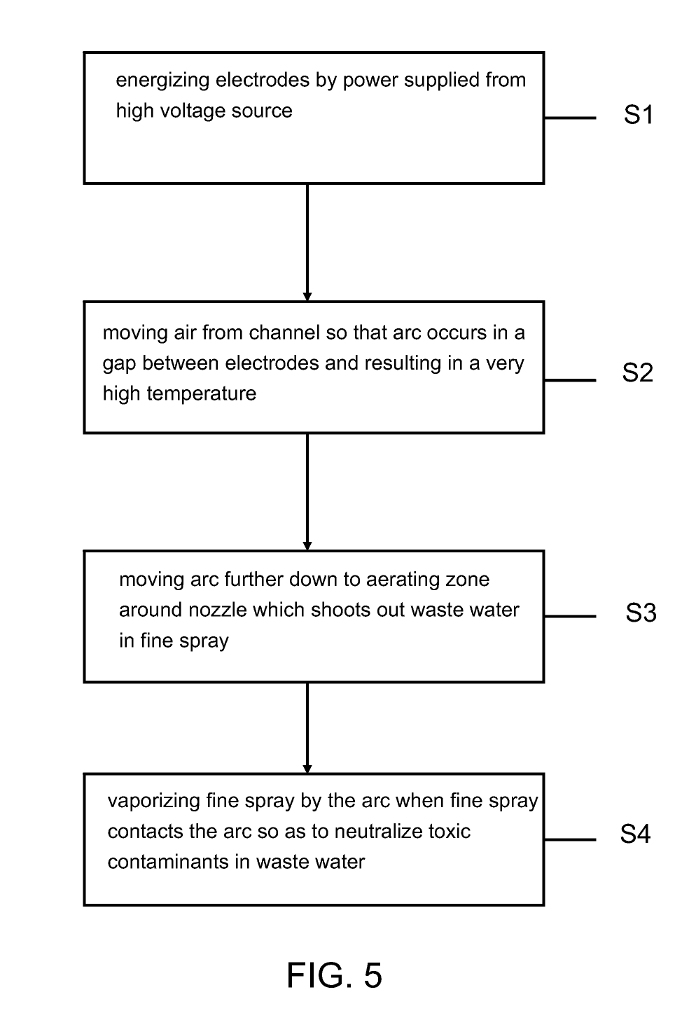

Referring to FIG. 5, a process for treating waste water in accordance with the invention comprises the following steps:

In step S1, the electrodes 23 are energized by power supplied from the high voltage source 21.

In step S2, air moves in the rate of about 10 meter/second from the channel 25 so that arc may occur in the gap between the electrodes 23 and it results in a very high temperature (e.g., in the rage of about 500° C. to about 7,000° C. with an average of about 1,000° C.).

In step S3, the arc further moves to an aerating zone 27 around the nozzle 3 which shoots out contaminants and water components of waste water in fine spray as waste water supplied from the waste water source 20.

In step S4, the fine spray is simultaneously vaporized by the arc when it contacts the arc so that the toxic contaminants are neutralized.

While the invention has been described in terms of preferred embodiments, those skilled in the art will recognize that the invention can be practiced with modifications within the spirit and scope of the appended claims.

What is claimed is:

1. In an apparatus including two opposite conductive electrodes mounted in an opening of an insulating shroud filled with pressurized air, a support for supporting the shroud, the support being in communication with the opening to define an aerating zone adjacent to the opening, a collection tank under the aerating zone, and a nozzle disposed in the aerating zone, the nozzle being in communication with a waste water source, a process for treating waste water comprising the steps of:
energizing the electrodes to generate arc in a gap between the electrodes as the pressurized air passing through the gap;
moving the arc to the aerating zone with contaminants and water components of waste water being shot out in fine spray from the nozzle; and
vaporizing the fine spray as when it contacts the arc so as to neutralize the contaminants.

2. A nozzle for use in waste water treatment, comprising:
a first half and a second half releasably secured to the first half to form a space therein;
a plurality of surface apertures formed on the first and second halves; and
a threaded hole disposed in the first half.

3. The nozzle of claim 1, wherein the first and second halves together are shaped as a sphere.
